(19) United States
(12) Patent Application Publication
(10) Pub. No.: US 2016/0371726 A1
(43) Pub. Date: Dec. 22, 2016

(54) INFORMATION PROCESSING APPARATUS, INFORMATION PROCESSING METHOD, AND COMPUTER PROGRAM PRODUCT

(71) Applicant: Kabushiki Kaisha Toshiba, Tokyo (JP)

(72) Inventors: Yuto YAMAJI, Kawasaki Kanagawa (JP); Tomoki WATANABE, Inagi Tokyo (JP); Tomokazu KAWAHARA, Yokohama Kanagawa (JP); Tomoyuki SHIBATA, Kawasaki Kanagawa (JP); Osamu YAMAGUCHI, Yokohama Kanagawa (JP)

(21) Appl. No.: 15/188,358

(22) Filed: Jun. 21, 2016

(30) Foreign Application Priority Data
Jun. 22, 2015 (JP) 2015-125015
Mar. 22, 2016 (JP) 2016-057512

(51) Int. Cl. G06Q 30/02; G06F 3/01; G06K 9/00; G09G 5/00

(52) U.S. Cl. CPC G06Q 30/0246; G09G 5/003; G06F 3/013; G06K 9/00369; G06K 9/00255

(57) ABSTRACT

According to an embodiment, an information processing apparatus includes a processor. The processer is configured to measure a viewing time indicating a time during which a person existing in front of a display medium views the display medium; control, in a variable manner, a threshold of the viewing time based on content of the display medium; and count a number of object persons, the object person indicating a person with the viewing time equal to or greater than the threshold.

### CROSS-REFERENCE TO RELATED APPLICATION(S)

This application is based upon and claims the benefit of priority from Japanese Patent Applications No. 2015-125015, filed on Jun. 22, 2015, and No. 2016-057512, filed on Mar. 22, 2016; the entire contents of which are incorporated herein by reference.

### FIELD

Embodiments described herein relate generally to an information processing apparatus, an information processing method, and a computer program product.

### BACKGROUND

Conventionally, technologies of analyzing an image captured by a camera or the like, measuring the number of persons who are paying attention to a display medium such as a signboard or an image (digital signage or the like), and measuring an advertising effect (an advertisement effect through the display medium) using a measurement result are known.

However, forms of the display medium have become diverse, and a time required for a viewer to understand advertisement contents of the display medium (the time is referred to as “necessary time of attention” for convenience of description) differs depending on the display medium. In the conventional technologies, without considering the necessary time of attention of the display medium at all, even a viewer with a viewing time of the display medium falling below the necessary time of attention is counted as a viewer who is paying attention to the display medium. Therefore, the number of persons from which the advertisement effect through the display medium cannot be expected is included in the number of persons who are paying attention to the display medium. That is, in the conventional technologies, only the number of persons from which the advertisement effect through the display medium can be expected cannot be counted as the number of persons who are paying attention to the display medium. Therefore, there is a problem that accuracy of a measurement result of an advertising effect is low.

### BRIEF DESCRIPTION OF THE DRAWINGS

FIG. 1 is a diagram illustrating a hardware configuration of an information processing apparatus of a first embodiment;

FIG. 2 is a diagram illustrating functions included in the information processing apparatus of the first embodiment;

FIGS. 3A and 3B are diagrams illustrating installation of a camera of the first embodiment;

FIG. 4 is a diagram for describing a method of detecting a viewing person of the first embodiment;

FIG. 5 is a diagram illustrating a measurement result by a measurer of the first embodiment;

FIG. 6 is a diagram illustrating elements included in a display medium of the first embodiment;

FIG. 7 is a diagram illustrating correspondence information of the first embodiment;

FIG. 8 is a diagram for describing a method of determining a threshold in the first embodiment;

FIG. 9 is a diagram for describing a method of determining a threshold in the first embodiment;

FIG. 10 is a diagram for describing a method of determining a threshold in the first embodiment;

FIG. 11 is a diagram for describing a method of determining a threshold in the first embodiment;

FIG. 12 is a diagram for describing a method of determining a threshold in the first embodiment;

FIG. 13 is a diagram for describing a method of determining a threshold in the first embodiment;

FIGS. 14A and 14B are diagrams for describing a method of measuring a person of attention in the first embodiment;

FIG. 15 is a diagram illustrating processing performed by the information processing apparatus of the first embodiment;

FIG. 16 is a diagram illustrating functions included in an information processing apparatus of a second embodiment;

FIGS. 17A and 17B are diagrams for describing a method of measuring a person of attention in the second embodiment;

FIG. 18 is a diagram illustrating functions included in an information processing apparatus of a third embodiment;

FIG. 19 is a diagram illustrating functions included in an information processing apparatus of a fourth embodiment;

FIG. 20 is a diagram illustrating a measurement result by a measurer of the fourth embodiment;

FIG. 21 is a diagram for describing a method of measuring a person of attention in the fourth embodiment;

FIG. 22 is a diagram illustrating functions included in an information processing apparatus of a fifth embodiment;

FIG. 23 is a diagram for describing a unit of measurement of attention of the fifth embodiment;

FIG. 24 is a diagram for describing a display method of the fifth embodiment;

FIG. 25 is a diagram illustrating a flag table of the fifth embodiment;

FIG. 26 is a diagram illustrating functions included in an information processing apparatus of modification of the fifth embodiment;

FIG. 27 is a diagram for describing an object of measurement of attention of the modification; and

FIG. 28 is a diagram for describing a display method of the modification.

### DETAILED DESCRIPTION

According to an embodiment, an information processing apparatus includes a processor. The processer is configured to measure a viewing time indicating a time during which a person existing in front of a display medium views the display medium; control, in a variable manner, a threshold of the viewing time based on content of the display medium; and count a number of object persons, the object person indicating a person with the viewing time equal to or greater than the threshold.

Hereinafter, various embodiments will be described in detail with reference to the accompanying drawings.

### First Embodiment

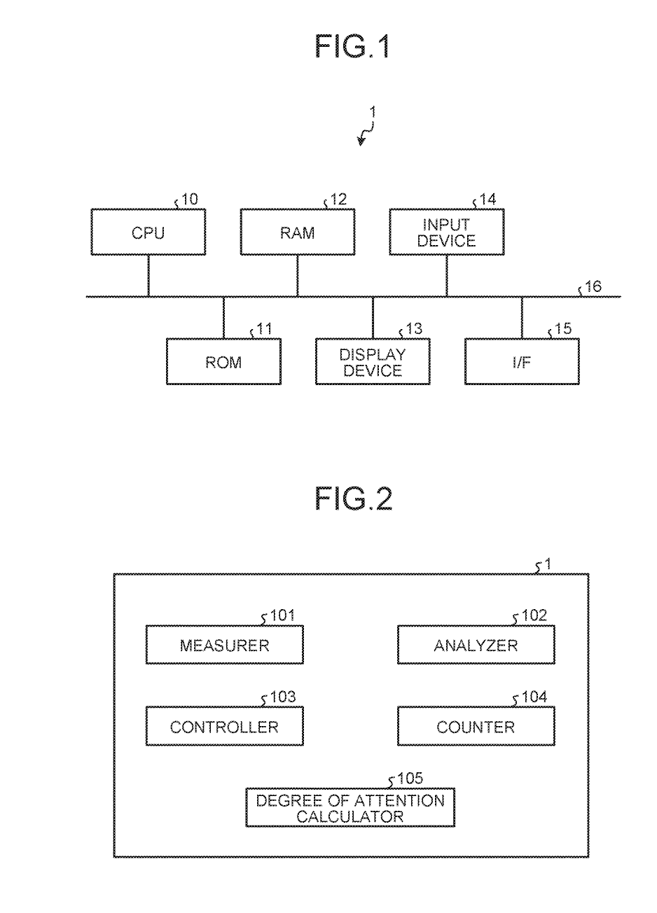

FIG. 1 is a diagram illustrating a hardware configuration of an information processing apparatus 1 of the first embodiment. The information processing apparatus 1 according to the first embodiment has a function of calculating the degree of attention (described below) used for measurement of an advertisement effect through a display medium such as a signboard, a digital signage, a television commercial, or web advertising, which is installed in a high-traffic area, a train, or the like. In the description below, a case of using an image as the display medium will be exemplarily described. The image may be a still image or a moving image. Note that a form of the display medium (contents) is arbitrary, and is not limited to the image.

As illustrated in FIG. 1, the information processing apparatus 1 includes a CPU 10, a ROM 11, a RAM 12, a display device 13, an input device 14, and an I/F 15, and these units and devices are mutually connected through a bus 16.

The CPU 10 centrally controls an operation of the information processing apparatus 1. The ROM 11 is a non-volatile memory that stores programs and various data. The RAM 12 is a volatile memory that functions as a work area of various types of arithmetic processing executed by the CPU 10. The display device 13 is a display device that displays various types of information, and is configured from a liquid crystal display device or the like. The input device 14 is a device used for various operations, and is configured from a mouse, a keyboard, and the like, for example. The I/F 15 is an interface for being connected with an external device (for example, a camera) or a network.

FIG. 2 is a diagram illustrating functions included in the information processing apparatus 1. As illustrated in FIG. 2, the information processing apparatus 1 includes a measurer 101, an analyzer 102, a controller 103, a counter 104, and a degree of attention calculator 105. In the example of FIG. 2, functions according to the first embodiment are mainly illustrated; however, the functions included in the information processing apparatus 1 are not limited to these functions. For example, the information processing apparatus 1 may include a function of displaying the display medium (the image in this example).

In the first embodiment, the functions included in the information processing apparatus 1 (the measurer 101, the analyzer 102, the controller 103, the counter 104, the degree of attention calculator 105, and the like) are implemented by execution of the program stored in the storage device such as the ROM 11, by the CPU 10. However, the way to implement the functions is not limited to the example, and for example, at least a part of the functions included in the information processing apparatus 1 may be implemented by a dedicated hardware circuit (a semiconductor integrated circuit, for example). Furthermore, for example, the functions included in the measurer 101, the analyzer 102, the controller 103, the counter 104, the degree of attention calculator 105, and the like may be distributively provided in a plurality of apparatuses. For example, the function included in the measurer 101 may be provided in another apparatus which is different from the information processing apparatus 1, and the information processing apparatus 1 may acquire a measurement result (a viewing time) of the measurer 101, which will be described later. That is, the information processing apparatus 1 may include at least the controller 103 and the counter 104.

The measurer 101 measures, for each person existing in front of the display medium, a viewing time during which the person views the display medium. In this example, the display medium is the image (advertisement image). Therefore, the measurer 101 first detects persons existing in front of an advertising display device that displays the display medium (for example, the advertising display device may be the information processing apparatus 1 itself or may be a another device separate from the information processing apparatus 1), then detects a person who is paying attention to the display medium, and measures the viewing time.

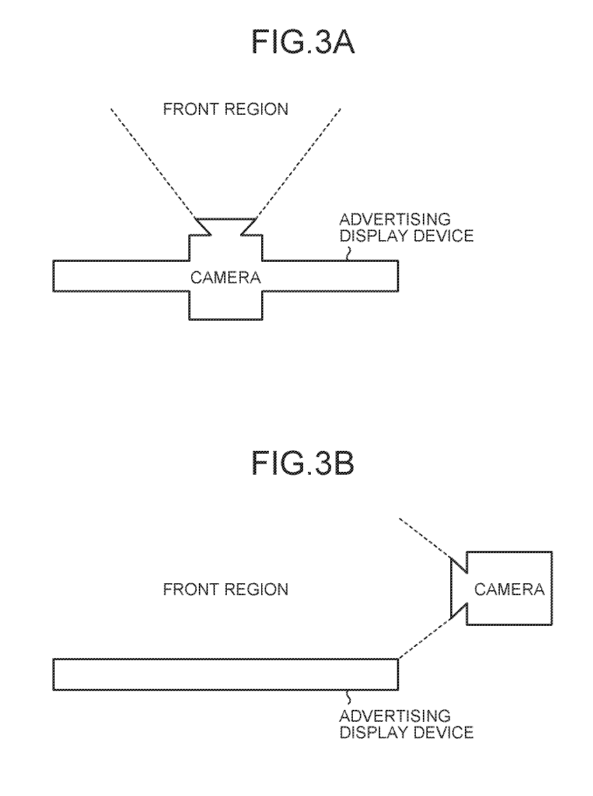

As a method of detecting persons existing in front of the advertising display device, for example, a method of installing a camera that captures a front region of the advertising display device, and detecting the persons included in an image captured by the camera (hereinafter, the image is referred to as “captured image”) by analyzing the captured image. An installation place of the camera is arbitrary. For example, as illustrated in FIG. 3A, the camera may be directly installed to the advertising display device, and capture the front of the persons existing in front of the advertising display device. Alternatively, for example, as illustrated in FIG. 3B, the camera may be installed in a place different from the advertising display device, and capture the side of the persons existing in front of the advertising display device. In either configuration the camera sequentially (at a constant period) captures the front region of the advertising display device, and the measurer 101 acquires the captured image obtained in the capturing every time the camera captures an image.

For convenience of description, hereinafter, description will be given on the assumption of the configuration illustrated in FIG. 3A. Every time the measurer 101 acquires the captured image from the camera, the measurer 101 analyzes the acquired captured image, and detects the persons appearing in the captured image. As a method of detecting a person from an image, various known technologies (for example, a technology disclosed in “T. Watanabe et al.: Co-occurrence histograms of oriented gradients for pedestrian detection, 2009” or the like) can be used. Further, the measurer 101 can detect faces or directions of the faces of the persons appearing in the captured image, and detect a person who turns his/her head toward the display medium, as a person who is viewing the display medium (hereinafter, may be referred to as “viewing person”). A method of detecting faces or directions of the faces of persons appearing in an image, various known technologies (for example, a technology disclosed in “T. Kozakaya et al.: Face Recognition by Projection-based 3D Normalization and Shading Subspace Orthogonalization, 2006” or the like) can be used.

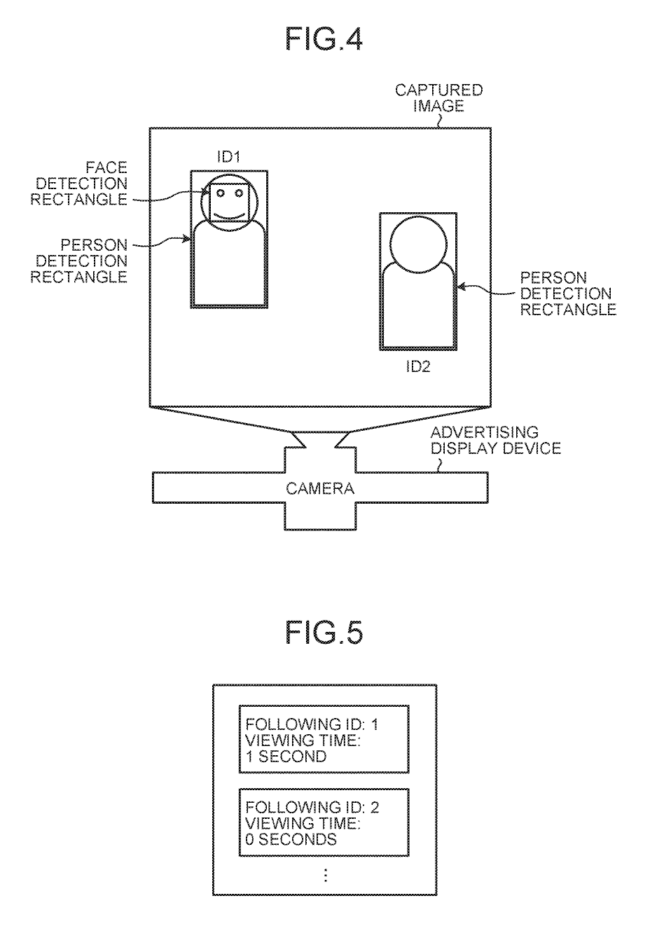

As described above, this example employs the configuration in which the camera is directly installed to the advertising display device, and captures the front of the persons existing in front of the advertising display device, as illustrated in FIG. 3A. Therefore, persons whose faces have been detected, among the persons appearing in the captured image, can be detected as the viewing persons who turns his/her head toward the display medium. For example, in the example of FIG. 4, a person whose face has been detected (a person corresponding to ID1 in the example of FIG. 4), of two persons appearing in the captured image (the person corresponding to ID 1 and a person corresponding to ID 2), can be detected as the viewing person.

Note that, as illustrated in FIG. 3B, in the configuration in which the camera is installed in a place different from the advertising display device, and captures the side of the persons existing in front of the advertising display device, when the direction of the face of the person appearing in the captured image is detected and the detected direction corresponds to a predetermined direction (a direction that is determined in advance, and by which the face can be determined to face the display medium), the person can be detected as the viewing person.

Next, the measurer 101 provides an ID to each detected person in order to measure the viewing time, and follows the detected person across frame images. As a method of following a person, various known technologies (for example, a technology disclosed in “V. Q. Pham et al.: DIET: Dynamic Integration of Extended Tracklets for Tracking Multiple Persons, 2014” or the like) can be used. The same function can also be implemented using face recognition technology. Detected faces are subjected to the frame-based face recognition, and an ID is assigned to faces of the same person. This can obtain the same results as those of the method of following a person. Then, the measurer 101 can measure (calculate), for each followed person, the viewing time of the person, from the number of frames in which the followed person has been detected as the viewing person, and a time indicating an acquisition interval of the captured image. FIG. 5 is a diagram illustrating a measurement result by the measurer 101.

Description of FIG. 2 will be continued. The analyzer 102 acquires the display medium (the image in this example) from the above-described advertising display device (for example, may be the information processing apparatus 1 itself, or may be a different device from the information processing apparatus 1), and analyzes elements included in the acquired display medium. The element included in the display medium points to a unit (unit of display) such as letter, photograph, graphic, diagram, and table. In the case where the element is a letter, a single letter is referred to as one element. In the case where the element is photograph, graphic, diagram, or table, a single separable block considered as a unit is referred to as one element.

First, a case in which the display medium is a still image will be exemplarily described. When the display medium is a file including meta-information such as a layout or element information, such as Microsoft Power Point, Adobe PDF, or Adobe Illustrator, instead of an image file, the elements can be analyzed from the meta-information. When the display medium is a file of Microsoft Power Point, the meta-information is described in an Open XML format, and a layout or sizes of letters can be analyzed by analyzing the XML file. Further, when the display medium is an image file, the letters can be specified as the elements included in the display medium, by detection of a letter portion by a technique disclosed in a known document (S. Saha et al.: A Hough Transform based Technique for Text Segmentation, 2010), and by discrimination by an optical character recognition (OCR) (a position and size can also be specified). Further, when a graphic or a photograph of a person is included in the display medium, the photograph or the graphic of the person can be specified as the element included in the display medium (a position and size can also be specified) by using the above-described person and face detection technique and various known technologies.

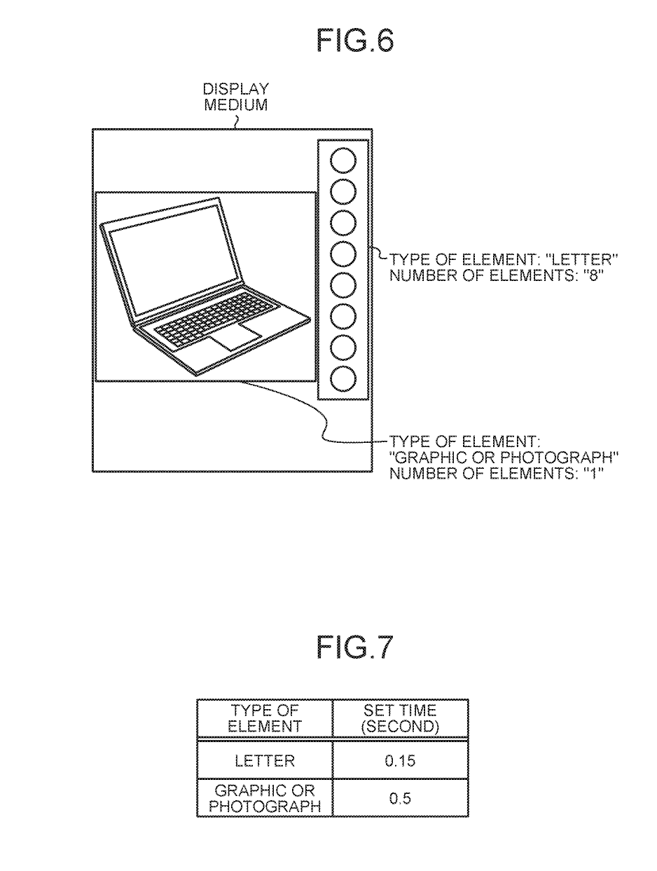

Next, for each type (category) of elements included in the display medium, the analyzer 102 counts the number of elements. For example, when the type of elements is “letter”, the analyzer 102 counts the number of letters (“8” in the example of FIG. 6) included in the display medium. When the type of element is “graphic or photograph”, the analyzer 102 counts the number of graphics or photographs (“1” in the example of FIG. 6) included in the display medium. The analyzer 102 then outputs information indicating the type and the number (the number of each type) of elements included in the display medium to the controller 103 (described below).

However, an embodiment is not limited thereto, and the analyzer 102 can analyze, for each set of elements of the same type (for example, a set of letters or a set of graphics or photographs), information indicating a ratio occupied by the set, in the display medium; for each element included in the display medium, information indicating a size of the element (the information may be information indicating the size of the element itself, may be information indicating a ratio occupied by the element, in the display medium, among a set to which the element belongs (a set of elements indicating the same type or a set of elements indicating the same type and size), or may be information indicating a ratio occupied by the element, in the display medium), and output the analyzed information to the controller 103 (described below).

Next, a case in which the display medium is a moving image will be exemplarily described. The analyzer 102 divides the moving image into a plurality of segments. Here, the segment can be regarded as a set of frames having an image change amount from a previous frame being less than a reference amount. Separation between the segments can be set at timing when a scene of the moving image makes a transition. The transition of the scene of the moving image may be extracted from an edit file of at the time of creation of the moving image, or may be detected by analyzing the moving image. As a method of detecting a scene of a moving image, various known technologies (for example, a technology disclosed in “D. Lelescu et al.: Statistical Sequential Analysis for Real-Time Video Scene Change Detection on Compressed Multimedia Bitstream, 2003” or the like) can be used. In this example, the analyzer 102 specifies, for each of the segments, a frame having a largest number of elements, among a plurality of frames belonging to the segment, as a representative frame. The analyzer 102 then outputs information indicating the type and the number of the elements included in each of a plurality of the representative frames corresponding to the plurality of segments on a one-to-one basis, to the controller 103 (described below).

Description of FIG. 2 will be continued. The controller 103 controls, in a variable manner, a threshold of the viewing time based on contents of the display medium. To be specific, the controller 103 controls, in a variable manner, the threshold of the viewing time based on the number of elements included in the display medium. To be more specific, the controller 103 controls the threshold in such a manner to exhibit a larger value as the number of elements is larger. In the first embodiment, the controller 103 specifies, for each element included in the display medium, a set time corresponding to the type of the element, based on correspondence information in which each of types of elements is associated with a set time indicating a predetermined time. Then, the controller 103 controls the threshold, according to a total sum of the set times specified for each element. Here, the set time indicates a time required to understand the corresponding type of the element (one element). That is, the set time is set to a time required for an average person to review one element of the corresponding type and understand the one element.

FIG. 7 is a diagram illustrating the correspondence information. For convenience of description, in the example of FIG. 7, the “letter” and the “graphic or photograph” are exemplarily described as the types of elements. However, the types of elements are not limited to the examples. In the example of FIG. 7, the set time corresponding to the “letter” is “0.15 seconds” that corresponds to an average time required for Japanese to read one letter. Further, the set time corresponding to the “graphic or photograph” is “0.5 seconds”. However, an embodiment is not limited to the examples.

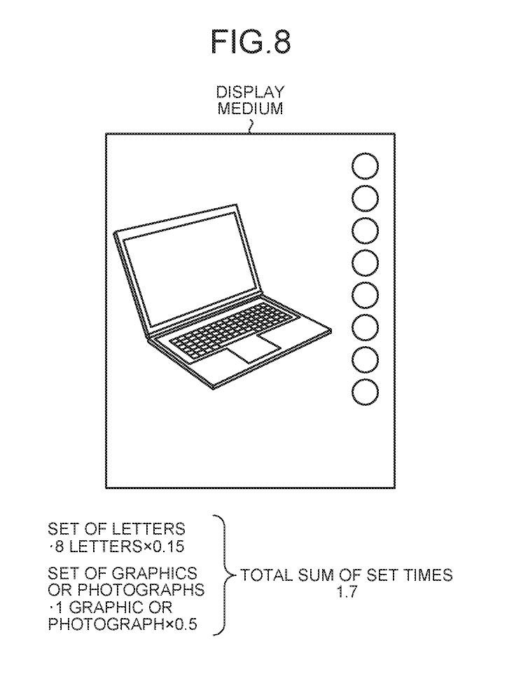

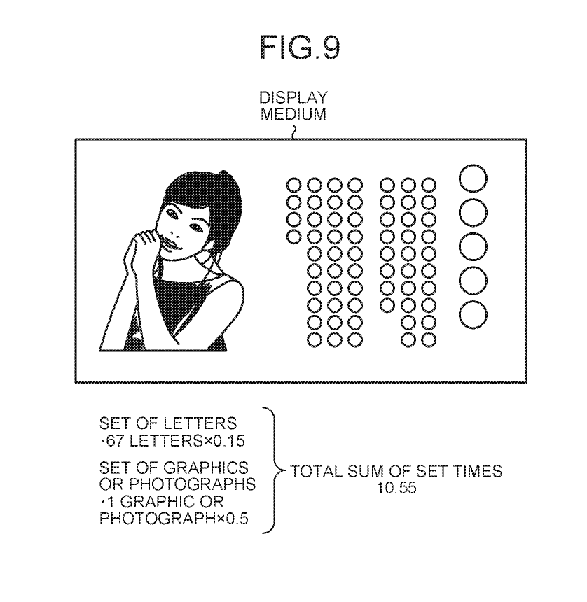

Hereinafter, a method of controlling a threshold will be described using a case in which the display medium is a still image. For example, as illustrated in FIG. 8, when the number of the “letters” included in the display medium (in the still image in this example) is “8”, and the number of the “graphics or photographs” is “1”, the total sum of the set times is calculated to be 0.15×8+0.5×1=1.7 (second). Further, as illustrated in FIG. 9, the number of “letters” included in the display medium is “67”, and the number of “graphics or photographs” is “1”, the total sum of the set times is calculated to be 0.15×67+1×0.5=10.55 (second).

Note that the above-described correspondence information may be information in which each of combinations of the types and sizes of the elements is associated with a set time. In this case, the controller 103 can specify, for each element included in the display medium, the set time corresponding to the combination of the type of the size of the element. In the correspondence information of this case, when the type of element is the “letter”, the set time may exhibit a larger value as the size of the letter is smaller, and when the type of element is the “graphic or photograph”, the set time may exhibit a larger value as the size of the graphic or the photograph is larger.

In the first embodiment, the controller 103 finally controls (determines) the total sum of the set times×a constant C, as the threshold. The constant C is a value indicating whether a person is counted as the person of attention by what percentage of the display medium the person views. When a person who has viewed all (100 percent) of the display medium is counted as the person of attention described below, the constant C is “1.0”. The constant C can be variably set according to an instruction of a user. Further, the constant C may be changed according to a position of the person who is viewing the display medium and the size of the display medium. For example, when a person is standing near a large display medium, the person needs to move his/her gaze in a large manner, and takes time to look over the entire display medium. Therefore, the constant C may be made large. Further, in a case of a landscape-oriented display medium installed in a passage, a person cannot recognize the entire display medium unless walking along the landscape direction (width direction) of the display medium, and takes time to look over the entire display medium. Therefore, the constant C may be made large. Further, the controller 103 may perform control such that the constant C may be omitted and the total sum of the set times is employed as the threshold.

Further, for example, the controller 103 can calculate, for each set of elements of the same type and size, first information indicating a sum of multiplication results each obtained by multiplying the set time corresponding to each of the elements belonging to the set by a weight corresponding to the size of the set, can calculate second information indicating a total sum of the first information of each set, and can control the threshold according to the second information.

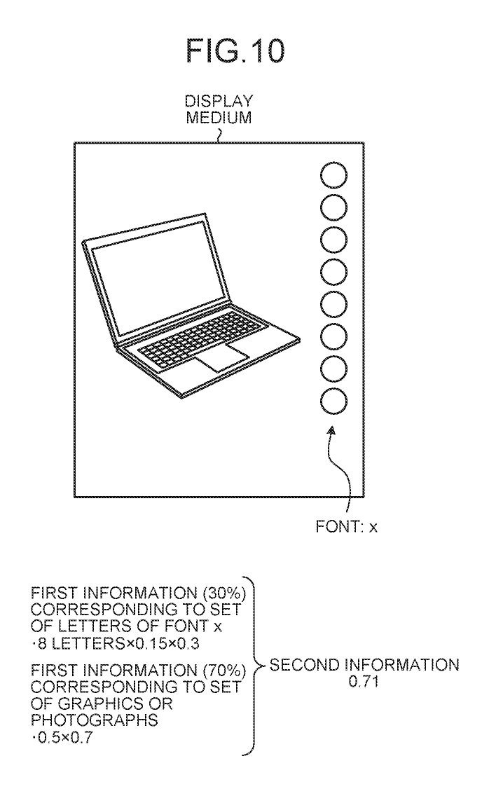

For example, assume a case in which the correspondence information is expressed in FIG. 7, and a ratio of an area occupied by a set of letters of a font x (8 letters in the example of FIG. 10) is 30%, and a ratio of an area occupied by a set of graphics or photographs (one graphic or photograph in the example of FIG. 10) is 70%, of the display medium, as illustrated in FIG. 10. In this case, the controller 103 calculates 0.15×8 (the number of the letters)×0.3 (corresponding to the weight according to the size of the set)=0.36 (second), as the first information corresponding to the set of letters of a font x, and calculates 0.5×1 (the number of the graphics)×0.7 (corresponding to the weight corresponding to the size of the set)=0.35 (second), as the first information corresponding to the set of graphics or photographs. Then, the controller 103 calculates 0.36+0.35=0.71 (second), as the second information, and can control a result of multiplication of the second information and the constant C, as the threshold, or can control the second information as it is, as the threshold.

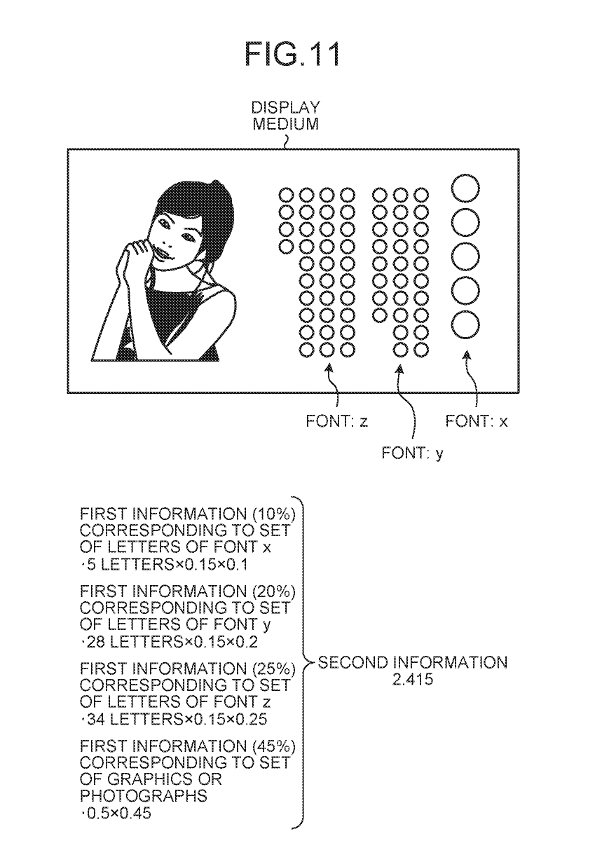

Further, for example, assume a case in which the correspondence information is expressed by the correspondence of FIG. 7, and a ratio of an area occupied by a set of letters of a font x (5 letters in the example of FIG. 11) is 10%, and a ratio of an area occupied by a set of letters of a font y (<x) (28 letters in the example of FIG. 11) is 20%, and a ratio of an area occupied by a set of letters of a font z (<y) (34 letters in the example of FIG. 11) is 25%, and a ratio of an area occupied by a set of graphics or photographs (one graphic or photograph in the example of FIG. 11) is 45%, in the display medium, as illustrated in FIG. 11. In this case, the controller 103 calculates 0.15×5 (the number of the letters belonging to the set)×0.1 (corresponding to the weight corresponding to the size of the set)=0.075 (second), as the first information corresponding to the set of letters of a font x, calculates 0.15×28 (the number of the letters belonging to the set)×0.2 (corresponding to the weight according to the size of the set)=0.84 (second), as the first information corresponding to the set of letters of a font y, calculates 0.15×34 (the number of the letters belonging to the set)×0.25 (corresponding to the weight according to the size of the set)=1.275 (second), as the first information corresponding to the set of letters of a font z, and calculates 0.5×1 (the number of the graphics belonging to the set)×0.45 (corresponding to the weight according to the size of the set)=0.225 (second), as the first information corresponding to the set of graphics or photographs. Further, the controller 103 calculates 0.075+0.84+1.275+0.225=2.415 (second), as the second information, and can control a result of multiplication of the second information and the constant C, as the threshold, or can control the second information as it is, as the threshold.

Further, the controller 103 can specify, among sets of elements of the same type, a set having the largest total sum of the set times corresponding to the elements belonging to the set, and can control the threshold according to the total sum of the set times corresponding to the specified set. For example, in the example of FIG. 8, the total sum of the set times corresponding to the set of letters is 0.15×8=1.2 (second), and the total sum of the set times corresponding to the set of graphics or photographs is 0.5×1=0.5 (second). Therefore, a set having the largest total sum of the set times is the set of letters. Therefore, the controller 103 can control the threshold according to the total sum of the set times corresponding to the set of letters. For example, the controller 103 can control the total sum (=1.2 seconds) of the set times corresponding to the set of letters, as the threshold, without using the constant C.

Alternatively, the controller 103 can specify, among sets of elements of the same type and size, a set having the largest total sum of the set times corresponding to the elements belonging to the set, and control the threshold according to the total sum of the set times corresponding to the specified set. For example, in the example of FIG. 11, the total sum of the set times corresponding to the set of letters of a font x is 0.15×5 (the number of the letters belonging to the set)=0.75 (second), the total sum of the set times corresponding to the set of letters of a font y is 0.15×28 (the number of the letters belonging to the set)=4.2 (second), the total sum of the set times corresponding to the set of letters of a font z is 0.15×34 (the number of the letters belonging to the set)=5.1 (second), and the total sum of the set times corresponding to the set of graphics or photographs is 0.5×1 (the number of the graphics belonging to the set)=0.5 (second). Therefore, the set having the largest total sum of the set times is the set of letters of a font z. Therefore, the controller 103 can control the threshold according to the total sum of the set times corresponding to the set of letters of a font z. For example, the controller 103 can control the total sum (=5.1 seconds) of the set times corresponding to the set of letters of a font z, as the threshold, without using the constant C.

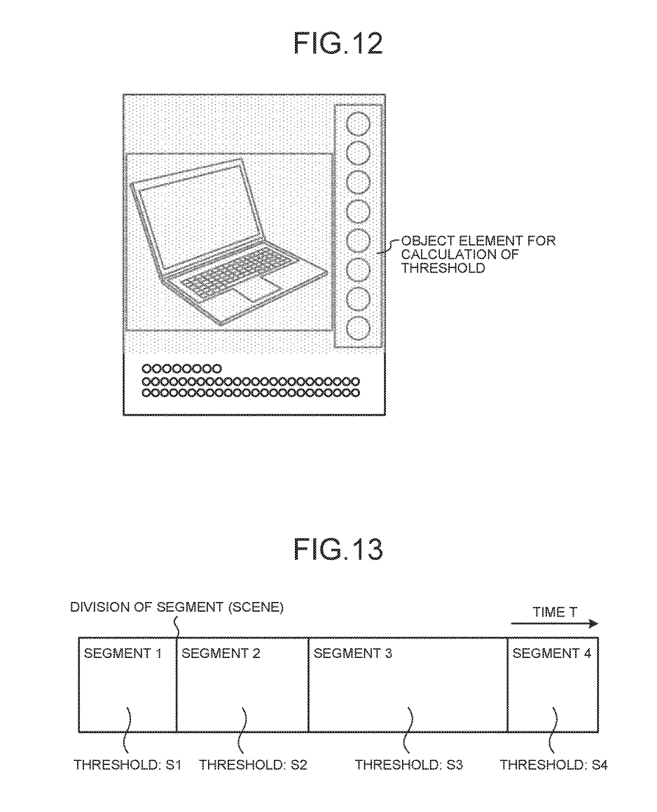

Still alternatively, as illustrated in FIG. 12, the controller 103 can control the threshold without using an element having a size less than a reference value. The display medium may include a region directly irrelevant to the contents of the advertisement, such as annotation. Therefore, the controller 103 may control the threshold, using only an element that exceeds the reference value, without using the element having the size less than the reference value.

Next, assume a case in which the display medium is a moving image. In this case, as illustrated in FIG. 13, the controller 103 controls, for each segment, a threshold corresponding to the segment. For example, the controller 103 can control the threshold corresponding to the segment, using the frame (representative frame) having the largest number of elements, among a plurality of frames belonging to the segment. A method of controlling the threshold in this case is similar to the method of controlling the threshold in the case of a still image.

As described above, the controller 103 controls the threshold in such a manner to exhibit a large value as the number of elements included in the display medium is larger. That is, the controller 103 can control, for each display medium, the time corresponding to the time required for the viewer to understand the advertisement contents (advertising contents) of the display medium, as the threshold.

Description of FIG. 2 will be continued. The counter 104 counts the number of object persons indicating the person with the viewing time being equal to or greater than the threshold. In the following description, the object person is referred to as “persons of attention”. In the first embodiment, the counter 104 specifies a person with the viewing time measured by the measurer 101 being equal to or greater than the threshold controlled by the controller 103, among persons (persons detected by the measurer 101) appearing in the captured image, as the person of attention, and counts the number of the specified persons of attention. Here, the person of attention is a person who has viewed the display medium for the time required to understand the advertisement contents of the display medium or greater, and can be considered as a person from which an advertisement effect by the display medium can be expected.

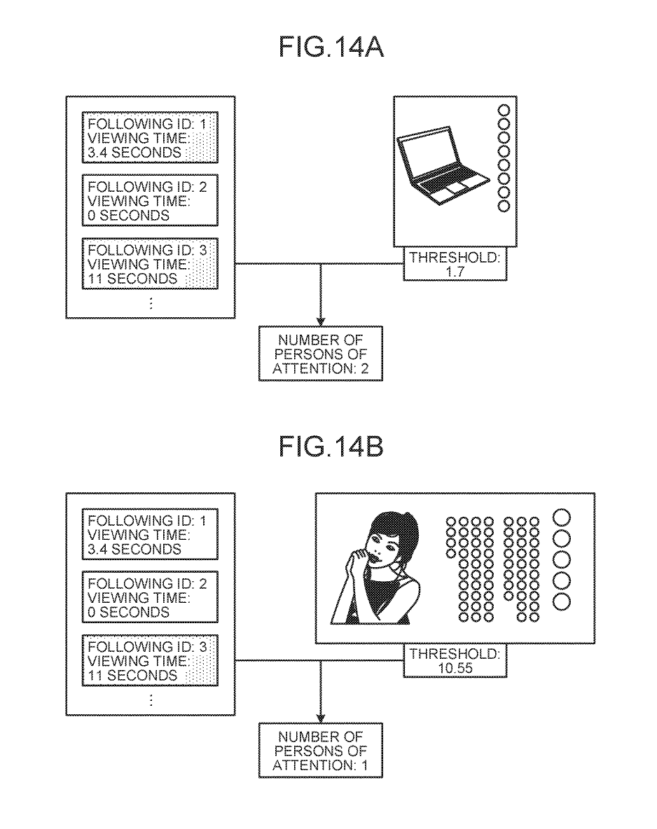

For example, in the example of FIG. 14A, the threshold controlled by the controller 103 is 1.7 seconds, and the person with the viewing time exceeding the threshold, the viewing time being measured by the measurer 101, among persons existing in front of the display medium (the still image in this example) (a person corresponding to ID 1, a person corresponding to ID 2, and a person corresponding to ID 3), is the person corresponding to ID 1 (the viewing time: 3.4 seconds) and the person corresponding to ID 3 (the viewing time: 11 seconds). Therefore, the number of persons of attention is counted to be “2”.

Further, in the example of FIG. 14B, the threshold controlled by the controller 103 is 10.55 seconds, and the person with the viewing time being equal to or greater than the threshold, the viewing time being measured by the measurer 101, among persons existing in front of the display medium (a still image in this example) (a person corresponding to ID 1, a person corresponding to ID 2, and a person corresponding to ID 3), is only the person corresponding to ID 3 (the viewing time: 11 seconds). Therefore, the number of persons of attention is counted to be “1”.

Further, for example, when the display medium is a moving image, the counter 104 resets the viewing times of all of the persons to 0, at timing when a playback time of the moving image crosses segments, determines whether the viewing time is equal to or greater than the threshold, for each segment, and counts the number of persons of attention. That is, the counter 104 counts the number of segments having the viewing time being equal to or greater than the threshold, for each person existing in front of the display medium (for each person detected/followed by the measurer 101). Next, the counter 104 counts the number of persons of attention, where a person with a value V1 exceeding a constant V0 is the person of attention, the value V1 being obtained such that the number of segments having the viewing time being equal to or greater than the threshold is divided by the total number of segments, among the persons existing in front of the display medium. The counter 104 may use a total sum V2 that is a result of multiplication of the playback time of the segment and a ratio occupied by the playback time of the segment, of the playback time of the entire moving image, for each segment having the viewing time being equal to or greater than the threshold, in place of the value V1. The values V1 and V2 are a ratio occupied by a segment of attention (the segment having the viewing time being equal to or greater than the threshold), of the entire moving image. For example, when the constant V0 is 0.5, the counter 104 counts a person who has paid attention to 50% or greater of the entire moving image, as the person of attention. The constant V0 may be set for each moving image, in advance, or a plurality of the constants V0 is prepared and the number of a plurality of types of persons of attention may be output. When the counter 104 counts a person who has paid attention to the entire moving image, as the person of attention, the constant V0 is set to 1.0. Note that the counter 104 may select only a segment having a maximum corresponding threshold, from among a plurality of segments, without using the constant V0, and count a person with the viewing time being equal to or greater than the threshold, among the persons existing in front of the display medium (the persons detected/followed by the measurer 101), as the person of attention.

All of the configurations are included in the concept of “the counter 104 counts the number of object persons indicating the persons with the viewing time being equal to or greater than the threshold”.

Description of FIG. 2 will be continued. The degree of attention calculator 105 calculates a result of dividing the number of persons of attention counted by the counter 104 by a unit time T (one minute or one hour, for example), as the degree of attention. The degree of attention of this case is defined as the number of persons of attention per unit time T. Further, an embodiment is not limited thereto, and for example, the degree of attention calculator 105 may calculate a value obtained by dividing the number of persons of attention counted by the counter 104 by the number of persons existing in front of the display medium (the number of persons detected/followed by the measurer 101), as the degree of attention. The degree of attention of this case is defined as a ratio occupied by the person of attention, among the persons existing in front of the display medium.

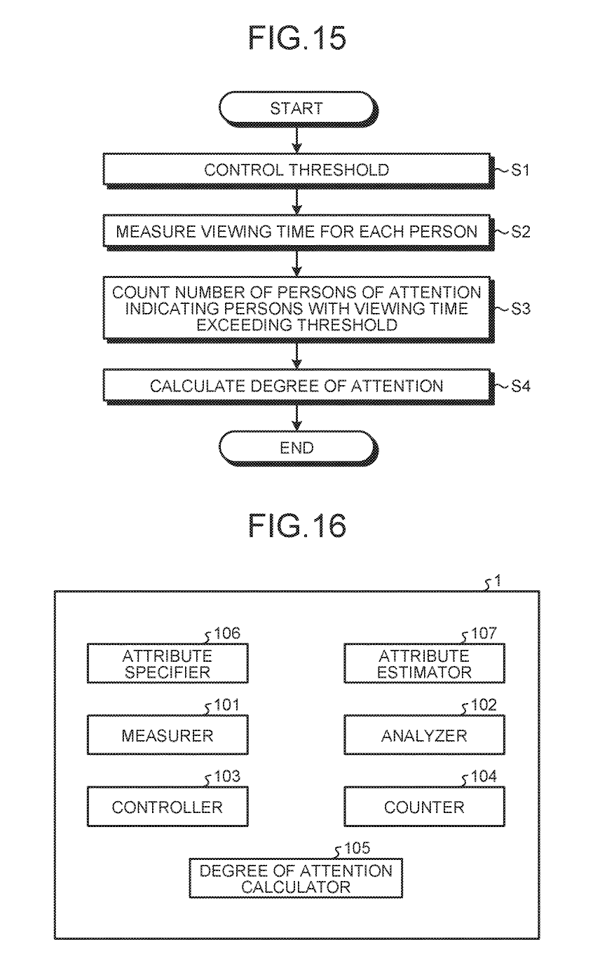

FIG. 15 is a flowchart illustrating processing performed by the information processing apparatus 1. As illustrated in FIG. 15, the controller 103 controls the threshold of the viewing time according to the number of elements included in the display medium (step S1). Specific contents have been described above. The measurer 101 measures the viewing time for each person existing in front of the display medium (step S2). Specific contents have been described above. Next, the counter 104 counts the number of persons of attention indicating the persons with the viewing time being equal to or greater than the threshold (step S3). Specific contents have been described above. Then, the degree of attention calculator 105 calculates the degree of attention, using the number of persons of attention measured in step S3 (step S4). Specific contents have been described above.

As described above, in the present embodiment, the threshold of the viewing time is controlled according to the number of elements included in the display medium, and the number of persons of attention indicating the persons with the viewing time being equal to or greater than the threshold of the display medium, among the persons existing in front of the display medium, is counted. Here, the threshold is controlled in such a manner to exhibit a larger value as the number of elements included in the display medium is larger, so that the time corresponding to the time required for the viewer to understand the advertisement contents (advertising contents) of the display medium can be controlled for each display medium. Accordingly, a person who has viewed the display medium for the time required to understand the advertisement contents of the display medium (the time corresponding to the threshold), among the persons existing in front of the display medium, that is, only the person from which the advertisement effect by the display medium can be expected can be counted as the person of attention. Therefore, when the advertising effect is measured using the number of persons of attention, accuracy of a measurement result of the measurement can be enhanced.

### Second Embodiment

Next, a second embodiment will be described. Description of portions common to the above-described first embodiment will be appropriately omitted. The second embodiment is different from the above-described first embodiment in that persons for which whether a viewing time is equal to or greater than a threshold is determined can be narrowed down, based on an attribute of persons existing in front of a display medium.

FIG. 16 is a diagram illustrating functions included in an information processing apparatus 1 of the second embodiment. As illustrated in FIG. 16, the information processing apparatus 1 is different from the above-described first embodiment in further including an attribute specifier 106 that specifies an attribute and an attribute estimator 107. For example, the attribute specifier 106 can specify an attribute such as an age or a sex, according to an operation of a user. In this example, the attribute is a combination of the age and the sex. However, the attribute is not limited to the example.

The attribute estimator 107 estimates, for each of persons appearing in a captured image acquired from a camera (persons existing in front of the display medium), the attribute of the person. As a method of estimating an age or a sex of a person, various known method (for example, a technology disclosed in “Yamamoto et al.: Method of Estimating Person Attribute (age/sex) Strong for Change of Face Direction Using Facial Image, 2014” or the like) can be used.

A measurer 101 estimates the viewing time of a person having the attribute specified by the attribute specifier 106, among the persons existing in front of the display medium. In this example, the measurer 101 employs only a person with the attribute estimated by the attribute estimator 107 being matched with the attribute specified by the attribute specifier 106, among the persons appearing in the captured image acquired from the camera, as an object to be measured of the viewing time. Note that the measurer 101 may function as the attribute estimator 107.

Further, a counter 104 counts the number of persons with the viewing time being equal to or greater than the threshold, among persons having the attribute specified by the attribute specifier 106, as the number of persons of attention. Note that a method of controlling the threshold is similar to that in the first embodiment.

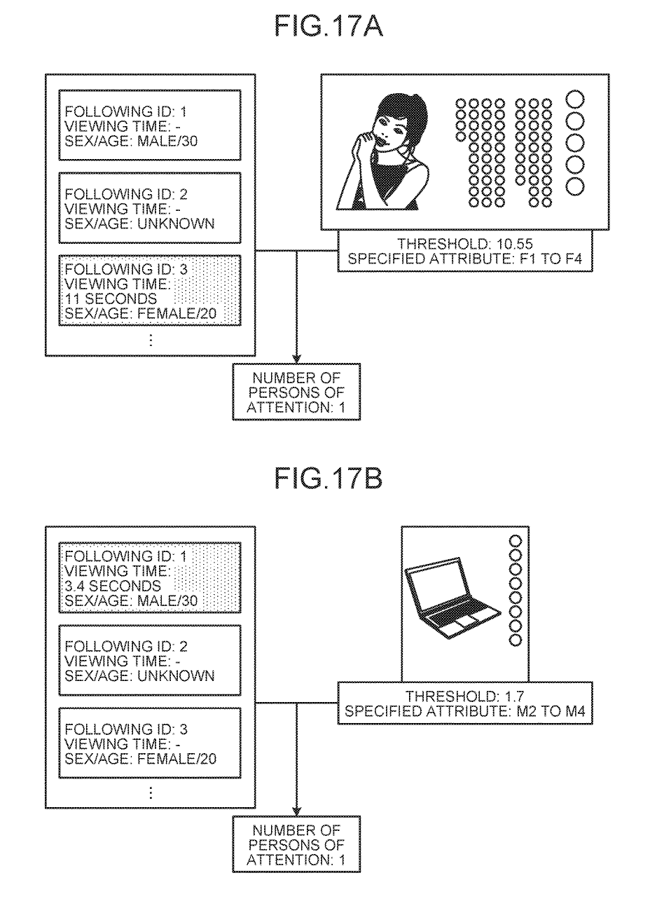

For example, as illustrated in FIG. 17A, assume a case in which the attribute specifier 106 specifies “F1 to F4” that indicates a combination of the sex “female” and the age “10s to 40s”, as the attribute. In the example of FIG. 17A, a person having the attributes of “F1 to F4”, among the persons existing in front of the display medium (a person corresponding to ID1, a person corresponding to ID 2, and a person corresponding to ID 3), only the person corresponding to ID 3. Therefore, the measurer 101 measures only the viewing time of the person corresponding to ID 3. Further, in the example of FIG. 17A, the person having the attributes of “F1 to F4” is only the person corresponding to ID 3, and the viewing time (11 seconds) of the person corresponding to ID 3 is equal to or greater than the threshold (10.55 seconds). Therefore, the counter 104 counts the number of persons of attention to be “1”.

Further, as illustrated in FIG. 17B, assume a case in which the attribute specifier 106 specifies “M2 to M4” that indicates a combination of the sex “male” and the age “20s to 40s”, as the attribute. In the example of FIG. 17B, a person having the attributes of “M2 to M4”, among the persons existing in front of the display medium (the person corresponding to ID1, the person corresponding to ID 2, and the person corresponding to ID 3), is only the person corresponding to ID 1. Therefore, the measurer 101 measures only the viewing time of the person corresponding to ID 1. Further, in the example of FIG. 17B, the person having the attributes of “M2 to M4” is only the person corresponding to ID 1, and the viewing time (3.4 seconds) of the person corresponding to ID 1 is equal to or greater than the threshold (1.7 seconds). Therefore, the counter 104 counts the number of persons of attention to be “1”.

In the above-described second embodiment, the attribute that serves as an advertisement target of the display medium is specified by the attribute specifier 106, so that only a person who is supposed to be the advertisement target, and from which an advertisement effect by the display medium can be expected, can be counted as the person of attention.

### Third Embodiment

Next, a third embodiment will be described. Description of portions common to the above-described first embodiment will be appropriately omitted. The third embodiment is different from the above-described first embodiment in that, for each of persons existing in front of a display medium, a threshold corresponding to the person is controlled according to the number of elements included in the display medium and an attribute of the person.

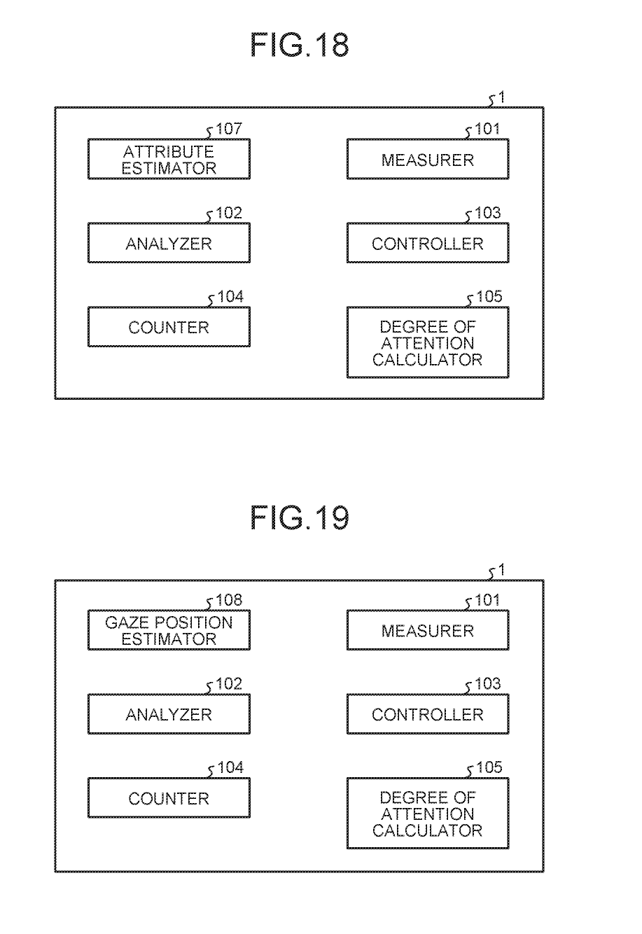

FIG. 18 is a diagram illustrating functions included in an information processing apparatus 1 of the third embodiment. As illustrated in FIG. 18, the information processing apparatus 1 is different from the above-describe first embodiment in further including an attribute estimator 107. The attribute estimator 107 estimates, for each of persons appearing in a captured image acquired from a camera (persons existing in front of the display medium), an attribute of the person. Similarly to the second embodiment, as a method of estimating an age or a sex of a person, various known methods can be used. For example, an measurer 101 may function as the attribute estimator 107.

A controller 103 controls, for each of the persons existing in front of the display medium, a threshold corresponding to the person according to the number of elements included in the display medium and the attribute of the person. That is, in the third embodiment, the threshold is individually set for each person existing in front of the display medium. For example, when the attribute of the person indicates an age falling outside a reference range, the controller 103 can control the threshold corresponding to the person in such a manner to exhibit a larger value than the case of an age falling within the reference range. Other configurations are similar to the first embodiment, and thus detailed description is omitted.

### Fourth Embodiment

Next, a fourth embodiment will be described. description of portions common to the above-described first embodiment will be appropriately omitted.

FIG. 19 is a diagram illustrating functions included in an information processing apparatus 1 of the fourth embodiment. As illustrated in FIG. 19, the information processing apparatus 1 is different from the first embodiment in further including a gaze position estimator 108. The gaze position estimator 108 estimates a position that a person is gazing at, in the display medium. In this example, the gaze position estimator 108 estimates, for each of persons appearing in a captured image acquired from a camera (persons existing in front of the display medium), the position that the person is gazing at, in the display medium. As a method of estimating a position that a person is gazing at, in a display medium, various known technologies (for example, a technology disclosed in “T. Ohno: FreeGaze: A Gaze Tracking System for Everyday Gaze Interaction, 2002” or the like) can be used. Further, a measurer 101 may function as the gaze position estimator 108.

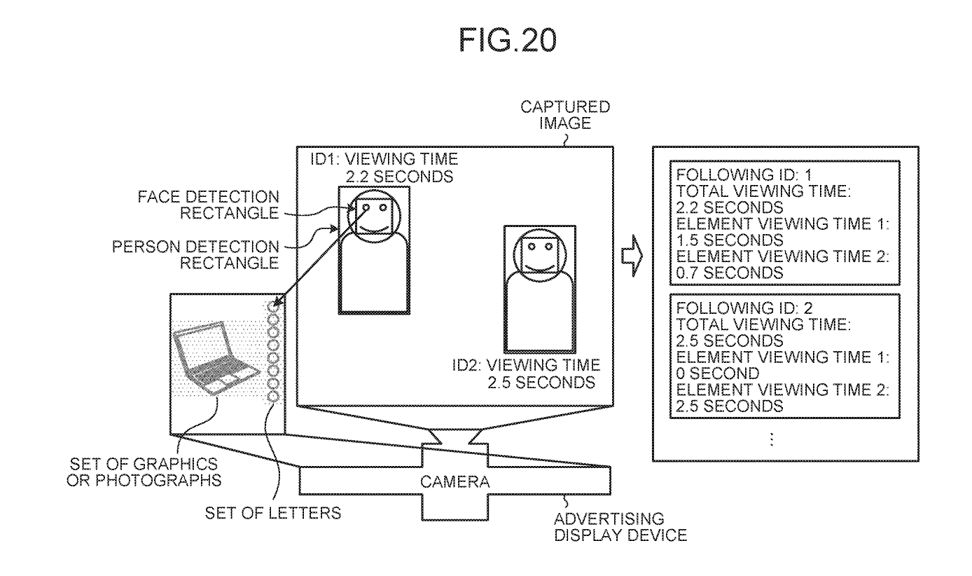

Further, the measurer 101 measures, for each of the persons existing in front of the display medium, a time during which the person views an element corresponding to the position that the person is gazing at, in the display medium, as an element viewing time to view a set to which the element belongs (a set of elements indicating the same type). For example, in the example of FIG. 20, the element viewing time corresponding to a set of letters is described as “element viewing time 1”, and the element viewing time corresponding to a set of graphics or photographs is described as “element viewing time 2”. In the example of FIG. 20, the element viewing time 1 of a person corresponding to ID 1 is “1.5 seconds”, the element viewing time 2 is “0.7 seconds”, and a total viewing time (a sum of the element viewing time 1 and the element viewing time 2) is “2.2 seconds”. Further, the element viewing time 1 of a person corresponding to ID 2 is “0 second”, the element viewing time 2 is “2.5 seconds”, and a total viewing time is “2.5 seconds”.

In the fourth embodiment, a controller 103 specifies, for each element included in the display medium, a set time corresponding to the type of the element, based on correspondence information in which each type of element is associated with a predetermined set time. Then, the controller 103 controls, for each set of elements of the same type, a threshold corresponding to a total sum of the set times corresponding to the elements belonging to the set. For example, the controller 103 can control the total sum of the set times corresponding to the elements belonging to a certain set, as the threshold corresponding to the certain set.

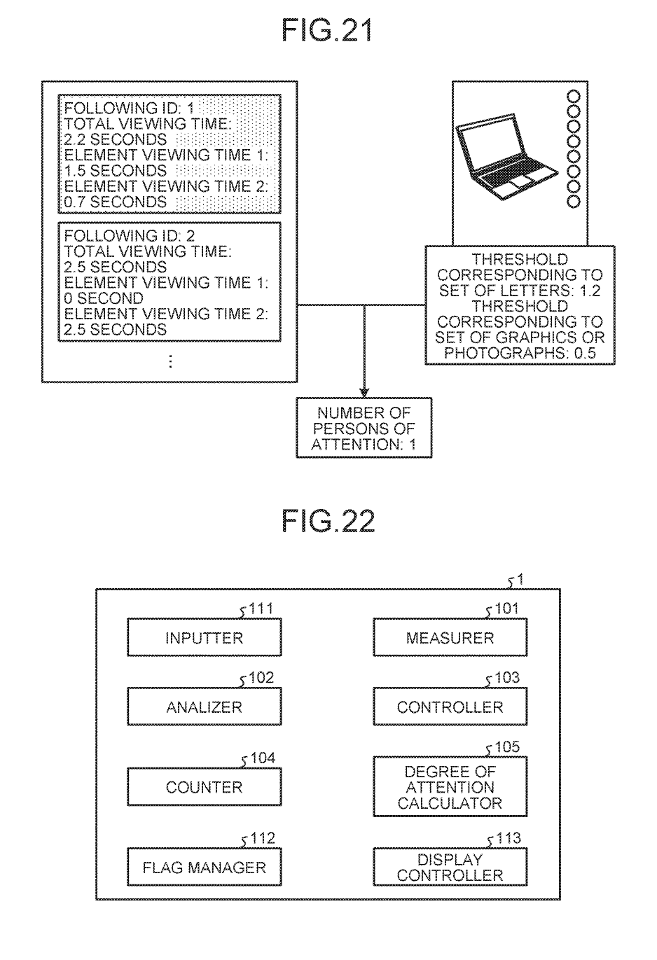

Further, a counter 104 counts a person with the element viewing time corresponding to each of a plurality of predetermined sets being equal to or greater than the threshold corresponding to the set, as a person of attention. For example, as illustrated in FIG. 21, assume a case in which the threshold corresponding to the set of letters is “1.2 seconds”, the threshold corresponding to the set of graphics or photographs is “0.5 seconds”, and as the plurality of predetermined sets, the set of letters and the set of graphics or photographs have been selected. In the example of FIG. 21, a person with the element viewing time 1 being equal to or greater than the threshold corresponding to the set of letters, and with the element viewing time 2 being equal to or greater than the threshold corresponding to the set of graphics or photographs is only the person corresponding to ID 1. Therefore, the counter 104 counts the number of persons of attention to be “1”.

In the above present embodiment, a fixed number of sets from which a high advertisement effect can be expected, of a plurality of sets (sets of elements of the same type) included in the display medium, is determined in advance, and a person with the element viewing time corresponding to each of the fixed number of set being equal to or greater than the threshold corresponding to the set is counted as the person of attention, so that only the person from which the advertisement effect by the display medium can be expected can be highly accurately counted.

### Modification of Fourth Embodiment

Further, for example, a counter 104 can count the number of persons of attention such that a person with an element viewing time corresponding to a specific set (for example, a set having a high degree of importance) being equal to or greater than a threshold corresponding to the specific set is the person of attention. Further, for example, the counter 104 can count the number of persons of attention such that a person with the element viewing time corresponding to a set having the largest number of elements (largest number of belonging elements), among a plurality of sets (sets of elements of the same type) included in a display medium, being equal to or greater than the threshold corresponding to the set is the person of attention.

### Fifth Embodiment

In the above-described embodiments, the display medium is the advertisement. However, the display medium is not limited to the advertisement. For example, the display medium may be a manual to be displayed in an electronic device. That is, an information processing apparatus 1 of the present embodiment can be used as an apparatus that keeps a record as to whether a worker has proceeded in work while confirming a work manual.

FIG. 22 is a diagram illustrating functions included in the information processing apparatus of the present embodiment. As illustrated in FIG. 22, the information processing apparatus 1 of the present embodiment further includes an inputter 111 that receives an input from the worker, a flag manager 112 that manages whether the worker has paid attention, and a display controller 113 that performs control of displaying a manual and caution described below.

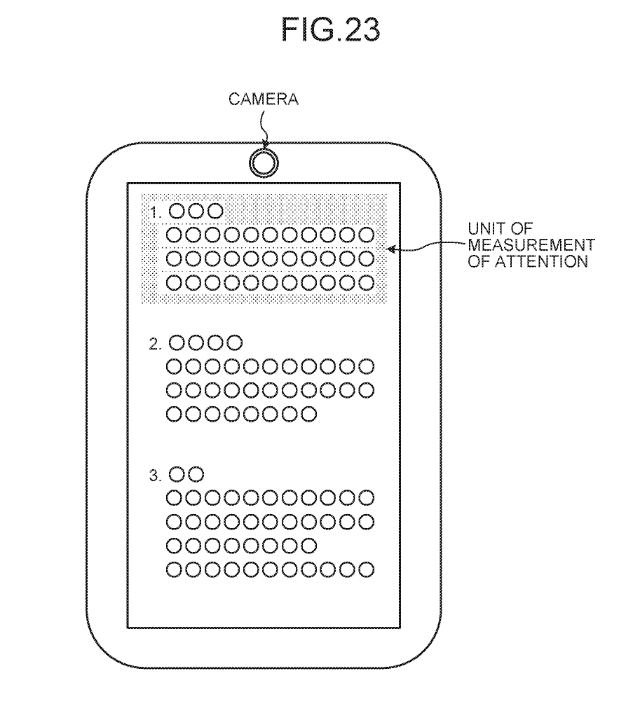

In the present embodiment, a measurer 101 uses each paragraph or each page of the manual as a unit of measurement of attention and measures a viewing time that indicates a time during which the worker has viewed the unit (FIG. 23). A controller 103 calculates a threshold of a time of attention (viewing time) from contents of the manual, similarly to the above-described embodiments, and the flag manager 112 sets, to an element (the unit of measurement of attention) with the viewing time that indicates the threshold or more, a flag that indicates that the worker has paid attention to the element. In a case where the unit of measurement of attention is a part of a page such as a paragraph, a gaze may be detected, similarly to the above-described fourth embodiment, and a portion of attention may be estimated.

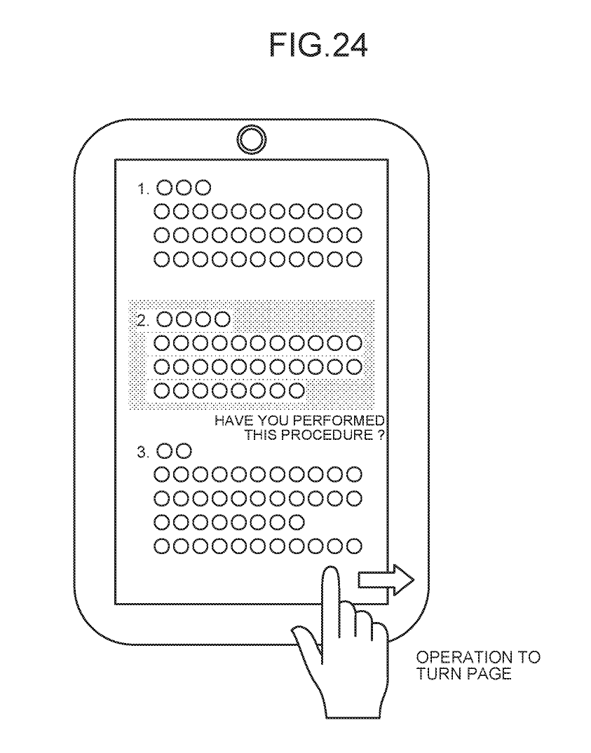

In the present embodiment, in a case where the flags are not set to all of the displayed units of measurement of attention when the worker has performed an operation to turn a page, the display controller 113 performs confirmation display as to whether the worker has performed work. As the confirmation display, a message such as “have you performed this procedure?” may be displayed like FIG. 24, or a portion to which no flag is set may be highlighted. Further, a portion to which attention has been paid (a portion with the viewing time that is equal to or greater than the threshold) may be displayed in a suppressed manner such that a color is lightened after passage of a certain time.

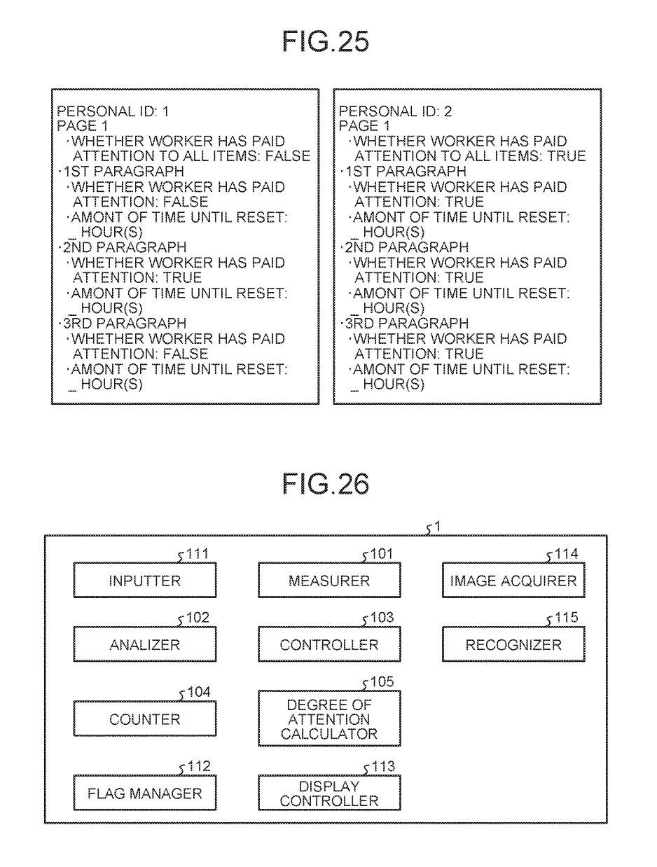

As illustrated in FIG. 25, the flag is managed by dividing a flag table for each ID allocated to each person who has been detected as a person existing in front of the display medium (in this example, the manual to be displayed). Considering a case where the worker forgets a work procedure, a system may unset the flag after passage of a certain time. A time to unset the flag may be set long to the same portion in the manual according to the number of times of setting of the flag.

### Modification of Fifth Embodiment

In this modification, an imaging device such as a camera and a display device that displays information are not necessarily integrated in the same device. An example is a case in which the imaging device is included in a pair of glasses or the like and an electronic device that displays a manual is included on a table or the like. In that case, the manual is not limited to an image to be displayed in the electronic device. As illustrated in FIG. 26, an information processing apparatus 1 of the present modification further includes an image acquirer 114 that acquires an image (captured image) obtained through imaging by the imaging device and a recognizer 115 that identifies the manual from the captured image acquired from the imaging device. For example, contents of the manual may be recognized by recognition using a template or an OCR, a threshold of a time of attention may be controlled in a variable manner, and whether a viewing time is equal to or greater than the threshold (whether a worker has paid attention) may be determined.

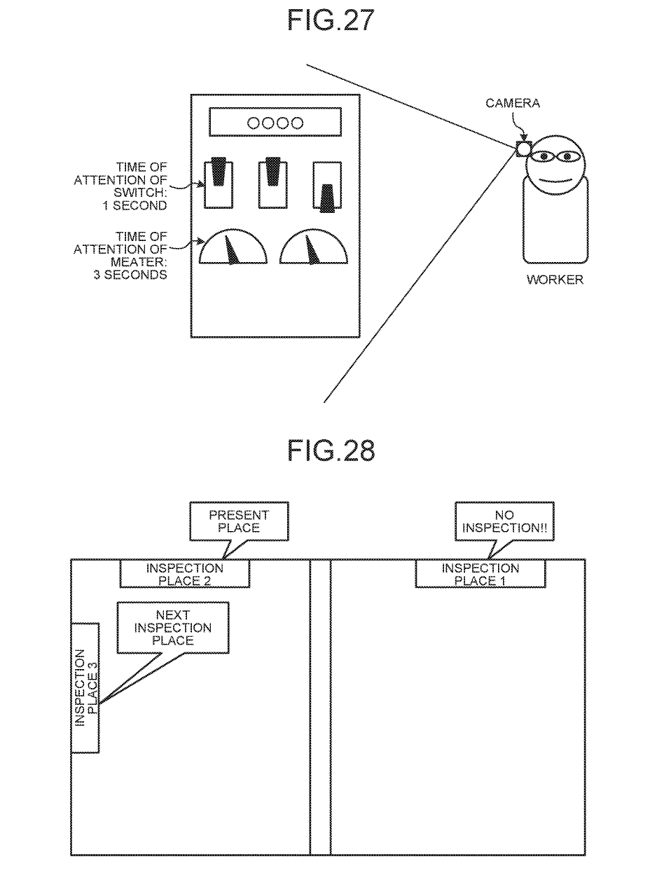

Further, in the present modification, an object of measurement of attention is not limited to the manual. For example, a specific place such as a work place or an inspection portion may be the object of measurement of attention (FIG. 27). For example, the imaging device (the camera or the like) is provided in the pair of glasses or the like used by the worker, and a place that serves as the object of measurement of attention can be recognized from a captured image obtained through imaging by the imaging device. A method of recognizing the place may be a method of performing comparison and determination using a character string recognized using the technology of the OCR if there are characters in the place to be recognized, or a method of performing matching using a template in a case of measuring instruments or the like. A threshold of a time of attention is determined using the number of elements such as the number of characters recognized by the OCR in the case of measuring attention to the characters, or the number of the measuring instruments in the case of the measuring instruments or the like. In the case of calculating the threshold using the number of the measuring instruments, the threshold may be calculated to be one second in a case where the measuring instruments are ones that indicate a binary state such as switches, or three seconds in a case where the measuring instruments are ones that can take multiple values such as meters. Further, in a case where a time of work or inspection is determined in advance, the time may be specified from an outside. The present modification may employ a form to estimate a position of a gaze, similarly to the above-described fourth embodiment, and measure the viewing time of only a position where the work or the inspection is to be performed.

Further, a place where the work or the inspection has been performed may be managed with a flag, similarly to the above-described fifth embodiment, and a place where no attention has been paid may be superimposed and displayed on a map in a tablet or a glass-type display device. Further, as illustrated in FIG. 28, after a flag that indicates that attention has been paid is set, a place where the work or the inspection will be performed next may be displayed. According to this example, whether a worker or an inspector has performed the work or the inspection according to a correct procedure can be measured.

The program executed in the information processing apparatus 1 of the above-described embodiments and modifications may be stored on a computer connected to a network such as the Internet, and provided by being downloaded through the network. Further, the program executed in the information processing apparatus 1 of the above-described embodiments and modifications may be provided or distributed through the network such as the Internet. Further, the program executed in the information processing apparatus 1 of the above-described embodiments and modifications may be incorporated in a non-volatile recording medium such as a ROM in advance and provided.

Further, the above-described embodiments and modifications can be arbitrarily combined.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising
a processor configured to
measure a viewing time indicating a time during which a person existing in front of a display medium views the display medium;
control, in a variable manner, a threshold of the viewing time based on content of the display medium; and
count a number of object persons, the object person indicating a person with the viewing time equal to or greater than the threshold.

2. The apparatus according to claim 1, wherein
the processor controls, in a variable manner, the threshold of the viewing time based on a number of elements included in the display medium.

3. The apparatus according to claim 2, wherein
the processor controls the threshold in such a manner to exhibit a larger value as the number of elements is larger.

4. The apparatus according to claim 2, wherein
based on correspondence information in which each of types of the elements is associated with a set time indicating a predetermined time, the processor specifies, for each of the elements, the set time corresponding to the type of the element.

5. The apparatus according to claim 4, wherein
the correspondence information is information in which each of combinations of the types and sizes of the elements is associated with the set time, and
the processor specifies, for each of the elements included in the display medium, the set time corresponding to the combination of the type and size of the element.

6. The apparatus according to claim 4, wherein
the processor controls the threshold, according to a total sum of the set times specified for each of the elements.

7. The apparatus according to claim 4, wherein
the processor
calculates, for each set of the elements of the same type and size, first information indicating a sum of multiplication results each obtained by multiplying the set time corresponding to each of the elements belonging to the set by a weight corresponding to the size of the set,
calculates second information indicating a total sum of the first information of the each set, and
controls the threshold according to the second information.

8. The apparatus according to claim 4, wherein
the processor specifies, among sets of the elements of the same type, the set having a largest total sum of the set times corresponding to the elements belonging to the set, and controls the threshold according to the set times corresponding to the specified set.

9. The apparatus according to claim 6, wherein
the processor controls the threshold without using the element having a size less than a reference value.

10. The apparatus according to claim 7, wherein
the processor controls the threshold without using the element having a size less than a reference value.

11. The apparatus according to claim 8, wherein
the processor controls the threshold without using the element having a size less than a reference value.

12. The apparatus according to claim 1, wherein
the display medium is a moving image,
for each segment whose unit is a set of frames having an image change amount from a previous frame being less than a reference amount, the processor controls the threshold corresponding to the segment, and
for the each segment, the processor determines whether the viewing time is equal to or greater than the threshold, so as to count the number of object persons.

13. The apparatus according to claim 12 wherein
the processor controls the threshold corresponding to the segment, using a frame having a largest number of the elements, among frames belonging to the segment.

14. The apparatus according to claim 1, wherein
the processor is further configured to specify an attribute, and
the processor
measures the viewing time of a person having the attribute specified by the attribute specifier, among persons existing in front of the display medium, and
counts, as the number of object persons, the number of persons with the viewing time equal to or greater than the threshold, among persons having the attribute specified by the attribute specifier.

15. The apparatus according to claim 14, wherein
for each of the persons existing in front of the display medium, the processor controls the threshold corresponding to the person based on the number of elements included in the display medium, and the attribute of the person.

16. The apparatus according to claim 15, wherein,
when the attribute of the person indicates an age falling outside a reference range, the processor controls the threshold corresponding to the person in such a manner to exhibit a larger value than a case where the attribute indicates an age falling within the reference range.

17. The apparatus according to claim 1, wherein
the processor
specifies, for each of the elements included in the display medium, the set time corresponding to the type of the element based on correspondence information in which each type of the elements is associated with a predetermined set time, and
controls, for each set of the elements of the same type, the threshold according to a total sum of the set times corresponding to the elements belonging to the set.

18. The apparatus according to claim 17, wherein
for each of persons existing in front of a display medium, the processor measures a time during which the person views the element corresponding to a position that the person is gazing at, of the display medium, as an element viewing time during which the person views the set to which the element belongs, and
the processor counts the number of object persons, where a person with the element viewing time predetermined and corresponding to each of the sets being equal to or greater than the threshold corresponding to the set is the object person.

19. The apparatus according to claim 17, wherein
for each of persons existing in front of a display medium, the processor measures a time during which the person views the element corresponding to a position that the person is gazing at, of the display medium, as an element viewing time during which the person views the set to which the element belongs, and
the processor counts the number of object persons, where a person with the element viewing time corresponding to a specific set being equal to or greater than the threshold corresponding to the specific set is the object person.

20. An information processing method comprising:
measuring a viewing time indicating a time during which a person existing in front of a display medium views the display medium;
controlling, in a variable manner, a threshold of the viewing time based on content of the display medium; and
counting a number of object persons, the object person indicating a person with the viewing time equal to or greater than the threshold.

21. A computer program product having a computer readable medium including programmed instructions, wherein the instructions, when executed by a computer, cause the computer to perform:
measuring a viewing time indicating a time during which a person existing in front of a display medium views the display medium;
controlling, in a variable manner, a threshold of the viewing time based on content of the display medium; and
counting a number of object persons, the object person indicating a person with the viewing time equal to or greater than the threshold.
